(19) United States
(12) Patent Application Publication
(10) Pub. No.: US 2025/0297083 A1
(43) Pub. Date: Sep. 25, 2025

(54) A METHOD FOR PRODUCING A COMPOUND COMPRISING A POLYHYDROXYALCANOATE AND CELLULOSE

(71) Applicants: SOCIETE DES PRODUITS NESTLE S.A., Vevey (CH); EMPA, EIDGENOSSISCHE MATERIALPRUFUNGS-UND FORSCHUNGSANSTALT, Dübendorf (CH)

(72) Inventors: MICHAEL KARLHEINZ HAUSMANN, Boudry (CH); GILBERTO SIQUEIRA, Zurich (CH); LISE ZEBOUDJ, Neuvecelle (FR); GUSTAV NYSTROM, Windisch (CH); THOMAS PETER GEIGER, Dubendorf (CH)

(21) Appl. No.: 18/847,064

(22) PCT Filed: Mar. 14, 2023
(86) PCT No.: PCT/EP2023/056399

§ 371 Date: Sep. 13, 2024

(30) Foreign Application Priority Data
Mar. 18, 2022 (EP) 22162867.0

(51) Int. Cl. C08L 1/02; B29B 9/06; B29B 9/14; B29K 1/00; B29K 67/00; B29K 105/00; C08J 5/04

(52) U.S. Cl. CPC C08L 1/02; B29B 9/14; C08J 5/045; B29B 9/06; B29K 2001/00; B29K 2067/00; B29K 2105/0014; B29K 2995/006; C08J 2301/02; C08J 2451/08; C08L 2201/06; C08L 2205/03; C08L 2205/06; C08L 2205/16

(57) ABSTRACT

Process for manufacturing a biodegradable compound, said process comprising the steps of, in order: (i) providing an extruder with at least one rotating screw, at least two feeding units suitable for being fed with ingredients, and an extruder die, (ii) feeding the first feeding unit with a PHA polymer and maleic anhydride (MA), (iii) feeding the second feeding unit with cellulosic fibres, (iv) rotating the screw to mix the PHA and maleic anhydride ingredients and graft said maleic anhydride onto said PHA molecules to form PHA grafted with MA (“PHA-g-MA”) in an amount of 1 to 10%, preferably 1 to 3% of the total content of PHA, and then mixing said PHA-g-MA with cellulosic fibres to form a molten compound of PHA-g-MA and cellulosic fibres, (v) passing said molten compound through said extruder die and shaping said extruded compound into different compound formats.

### CROSS REFERENCE TO RELATED APPLICATIONS

The present application is a National Stage of International Application No. PCT/EP2023/056399, filed on Mar. 14, 2023, which claims priority to European Patent Application No. 22162867.0, filed on Mar. 18, 2022, the entire contents of which are being incorporated herein by reference.

### FIELD OF THE INVENTION

The present invention concerns a process for manufacturing a compound comprising cellulosic fibres and a biodegradable polymer of the polyhydroxyalcanoate (PHA) type. The invention further concerns a compound obtained by such a manufacturing process.

### BACKGROUND OF THE INVENTION

Due to recent environmental awareness, the packaging industry has developed solutions to ensure that packaging materials do not utilize non-renewable resources, and that such packaging materials are either recyclable or biodegradable after use.

Materials that have been looked at as promising are polyhydroxyalcanoates polymers (PHAs). The PHA polymers are produced naturally by microorganisms, hence from renewable sources. Even more, such PHAs are produced from lipids which can origin from waste material, and therefore represent a virtuous source of packaging materials. In order to provide enhanced properties suitable for packaging, in particular improved mechanical properties, it was found that PHAs can be combined with cellulosic material, such as cellulose fibres.

However, compounding PHA polymers and cellulosic material was found to be difficult as such because of the uncertain chemical compatibility between the two ingredients.

Therefore, in order to compatibilize PHA and cellulosic material, techniques have been developed to chemically modify either the PHA molecules, or the cellulose fibres, such that they can both be compounded as a masterbatch, and the resulting compound thus obtained is stable chemically and mechanically. The compound masterbatch is then processed into an extruder to form pellets.

The compound pellets are then molten to be processed in their liquid form into packaging items, by conventional packaging-forming methods, for instance injection of 3D articles, extrusion, film lamination, compression of tridimensional items, etc.

One successful way of modifying PHA for compatibilization with cellulose fibres, is by chemically reacting a PHA molecule with maleic anhydride (MA), to obtain PHA molecules grafted with maleic anhydride (PHA-g-MA). The PHA-g-MA is relatively easy to compound with cellulosic fibres and the resulting compound is stable when transformed into pellets for further producing packages.

The techniques of grafting PHA with maleic anhydride into PHA-g-MA are now well known and described in the prior art.

For example, Shengnan et Al., in “Properties and structure of poly(3-hydroxybutyrate-co-4-hydroxybutyrate)/wood fiber biodegradable composites modified with maleic anhydride” (published in “Industrial Crops & Products”), discloses a PHA polymer compounded with wood fibres and grafted with maleic anhydride, to enhance the interfacial adhesion of the compound. This document is silent about the optimization of a manufacturing process.

US 2007/0287795 is a US patent application to Huda et Al., that discloses a composite composition which comprises a synthetic polymer, and corncob granules which have been modified such as with a chemical reacted with the hydroxyl groups on the granules. The corncob granules are modified so as to be compatible with the polymer, in particular by grafting maleic anhydride.

US2021079211 is a US patent that discloses a highly compatibilized biodegradable composite with high impact strength including: (a) a polymeric matrix having one or more biodegradable polymers; (b) one or more fillers; and (c) free radical initiators are fabricated via one-step reactive extrusion method. An in-situ free radical reaction method of manufacturing the biodegradable composite, including the step of (a) (1) mixing one or more biodegradable polymers and a free radical initiator; (2) melting step (1) thereby manufacturing the highly compatibilized biodegradable matrix. (b) Mixing the composites of step (a) and fillers or second biodegradable polymers, thereby manufacturing the biodegradable composite. Also, nano-blends are successfully prepared in this invention ascribe to the improved compatibility of the different components.

US 2013 225761 is a US patent application to Whitehouse et Al., that discloses a method for producing an aqueous PHA emulsion or latex comprising predominantly amorphous PHA polymers or copolymers with polymer dispersants or surfactants.

US 2018 127554 is a US patent application to Mohanty et Al., that discloses a biodegradable composite including: (a) a polymeric matrix having a biodegradable polymer; (b) a filler; and (c) an anhydride grafted compatibilizer including one or more biodegradable polymers modified with an anhydride group. The composite may also include (d) polymer additives such as polymer chain extenders or plasticizers.

Cheng Chen et Al., in “Synthesis and characterization of maleated poly(3-hydroxybutyrate)” (published 11 Feb. 2003 in “Journal of applied polymer science”) disclose graft copolymerization of maleic anhydride (MA) onto poly(3-hydroxybutyrate) (PHB) was carried out by use of benzoyl peroxide as initiator.

Another exemplary publication disclosing PHA-g-MA formation is Shengnan et Al. in “Properties and structure of poly(3-hydroxybutyrate-co-4-hydroxybutyrate)/wood fiber biodegradable composites modified with maleic anhydride” (published 5 Oct. 2017 in “Elsevier-Industrial Crops and Products, Volume 109, 15 Dec. 2017, Pages 882-888”). It discloses wood flour and P34HB composites were via hot pressing process, and the maleic anhydride (MAH) was added as the coupling agent to increase the interfacial adhesion.

Further, US2005225009 A1 is a US patent application that discloses a process for preparing a mouldable compound comprising cellulosic fibre and thermoplastic, for automotive, aerospace, furniture and other structural applications. This process comprises mixing cellulosic fibres, a surface-active agent and melted thermoplastics in a high shear mixing equipment. After later treatment, the compound is subjected to heat and pressure by compression and injection, to obtain complex shaped molded articles. The thermoplastic ingredient can be a PHA, and the surface-active agent can be a polymer grafted with maleic anhydride.

Such processes where a compound is formed by mixing a cellulosic ingredient with a PHA, therefore involve the use of compatibilizers which can be thermoplastics grafted maleic anhydride, or alternatively, such processes involve compounding the cellulosic material directly with a PHA which is grafted already with maleic anhydride.

In all cases, but especially in the case where PHA is selected as the preferred polymeric ingredient, in order to obtain compound pellets that are then suitable for forming a finished item, two phases are operated.

The first phase is the preparation of a PHA that is compatibilized for compounding with cellulose, more precisely a PHA-g-MA. The production of this material involves a chemical and heat treatment of the PHA to ensure grafting with maleic anhydride.

The second phase involves heating the PHA-g-MA until it reaches a molten state into an extruder, and mixing it in the extruder with a certain amount of cellulosic fibres, to obtain a PHA-cellulose compound, which is extruded into pellets. The pellets can then be used as a material to be processed into packaging items by diverse packaging-forming techniques such as injection, extrusion-blowing, film lamination, compression, etc.

The inventors have discovered that, although the above-mentioned techniques allow to produce excellent compound ready for production of packages, and said compound has desired recyclable and biodegradable properties, the treatment of PHA for grafting, and then extruding into pellets, degrades the PHA molecules and produces crotonic acid. Crotonic acid was found to be particularly detrimental to sensory properties of the compound. In particular, such crotonic acid was found to give bad off-taste to the products that are contained in packaging made of such compounds. Although attempts have been tried to reduce the content of crotonic acid in the final compound, the levels that are achieved were always found incompatible with packaging of edible items, especially for edible products having a neutral sensory profile, like mineral water, for instance. For other types of food products, the crotonic acid presents a risk to substantially modify the organoleptic properties of the product, in an inacceptable manner.

It is therefore an object of the present invention to provide a manufacturing process that obviates the above-mentioned disadvantages of the known processes, and provides an improved PHA-cellulose compound which solves sensory issues of the known compounds.

### SUMMARY OF THE INVENTION

The object of the invention is achieved with a process for manufacturing a biodegradable compound suitable for making packaging items, said compound comprising a mixture of cellulosic fibres and at least one type of polyhydroxyalcanoate polymer (PHA), said process comprising the steps of, in order:
(i) providing an extruder comprising a heater, at least one rotating screw, at least two feeding units suitable for being fed with ingredients, and an extruder die, the temperature of said extruder being set between 130° C. and 190° C., preferably between 130° C. and 175° C.,
(ii) feeding the first feeding unit with a PHA polymer and maleic anhydride (MA), wherein the ratio of maleic anhydride to PHA is comprised between 0.1 and 10, preferably between 0.1 and 5,
(iii) feeding the second feeding unit with cellulosic fibres, said cellulosic fibres being hardwood cellulose fibres having a length comprised within the range of 15 μm to 150 μm, preferably within the range of 20 μm to 120 μm, and having a density of at least 1.0 g/cm³, preferably of at least 1.5 g/cm³,
(iv) rotating the at least one screw to mix the PHA and maleic anhydride ingredients and graft said maleic anhydride onto said PHA molecules to form PHA grafted with MA (“PHA-g-MA”) in an amount of 1 to 10%, preferably 1 to 3% of the total content of PHA, and then mixing said PHA-g-MA with cellulosic fibres to form a molten compound of PHA-g-MA and cellulosic fibres,
(v) passing said molten compound through said extruder die, and shaping said extruded compound into, either:
   compound pellets, by cutting said extrudate compound cord with a knife system, or
   a compound film or compound plates (in this case, the extruder die takes the form of a cast line), or
   a compound tridimensional item, by injection moulding or extrusion blow-moulding said extruded compound into a mould.

With this process, the inventors have achieved grafting PHA with maleic anhydride, and simultaneously forming a stable compound with PHA-g-MA and cellulosic fibres, through a one-step approach in an extruder. This way, the resulting contains the desired fiber amount through a one step process, in particular, the final compound thus obtained is not only very stable chemically, but also contains a very high amount of cellulosic fibres per weight of the total compound, which makes the whole material suitable for either recycling through a standard paper recycling process, or biodegradability.

Furthermore, the inventors have discovered that the resulting compound of PHA-g-MA and cellulosic fibres, is characterized by excellent mechanical properties, especially regarding stiffness (Young's modulus), tensile strength, and elongation at break.

In a preferred embodiment of the invention, the extruder is a twin-screw extruder. The rotation speed of the at least one screw is preferably comprised between 10 rotations per minute (rpm) and 300 rpm, preferably the screw rotation speed is about 100 rpm.

Advantageously, a catalyst is added together with the PHA and the maleic anhydride in the first feeding unit. Such a catalyst is selected within the list of: dicumyl peroxide (DCP), benzoyl peroxide, dibenzoyl, hydroperoxides and ketone peroxides, or a combination thereof.

More precisely, in the preferred embodiment described above, the ratio of catalyst to PHA is comprised within the range of 0.01% to 5%, preferably it is a ratio of about 1%.

Also advantageously, a plasticizer can be added together with the cellulosic fibres into the second feeding unit, said plasticizer being selected within the list of: beeswax (BW), stearic acid (SA), glycerol monostearate (GMS), or a combination thereof.

In such a case, the ratio of plasticizer to cellulosic fibre is preferably comprised within the range of 0.1% to 10%, preferably the ratio is about 3%.

Generally, in the frame of the present invention, the polyhydroxyalcanoate polymer that is use, is preferably selected within the list of: poly3-hydroxybutyrate-co-3-hydroxyhexanoate (PHBH), poly-3-hydroxybutyrate-co-3-hydroxyvalerate (PHBV), poly-3-hydroxybutyrate (PHB), poly-3-hydroxyvalerate (PHV), or poly-3-hydroxyhexanoate (PHHx), and derivatives or combinations thereof.

In a highly preferred embodiment of the invention, the process comprises a step of quenching the extrudate compound within a quenching bath.

The temperature of said quenching bath is advantageously chosen between 5° C. and 50° C., preferably between 15° C. and 30° C., and the duration of the contact between the extrudate compound and the quenching bath is a few seconds, according to usual quenching practices. In principle, the quenching bath is water.

In one embodiment of the invention, the cellulosic fibres are advantageously modified by a coupling agent, in order to enhance their chemical compatibility with the PHA-g-MA. Preferably, said coupling agent is alkyl ketene dimer (AKD).

In one embodiment, the cellulosic fibres are compatibilized before being introduced into the second feeding unit. Alternatively, in a second embodiment, the natural cellulosic fibres are introduced together with the coupling agent within the second feeding unit, and the compatibilization reaction is performed directly in situ, inside the extruder. In this latter case, the compatibilized cellulosic fibres preferentially combine with the PHA-g-MA to form the PHA-cellulose compound.

Polyhydroxyalcanoate (PHA) polymers suitable for the invention are biodegradable polymers, preferably home compostable polymers. Home compostability is now well defined on a national level and mainly based on international standard EN 13432; therefore, they do not require to be further defined in-depth in the present specification. Materials or products compliant with these standards can be recognized by a conformity mark stating their home compostability. Some examples of home compostability certifications at a national level include, but are not limited to, the following. The certifier TÜV AUSTRIA BELGIUM offers such a home compostability certification scheme, and DIN CERTCO offers a certification for home compostability according to the Australian standard AS 5810. Italy has a national standard for composting at ambient temperature, UNI 11183:2006. In November 2015, the French Standard “NF T 51-800 Plastics—Specifications for plastics suitable for home composting” was introduced. This standard is covered in the DIN CERTCO scheme.

### BRIEF DESCRIPTION OF THE DRAWINGS

Additional features and advantages of the present invention are described in, and will be apparent from, the description of the presently preferred embodiments which are set out below with reference to the drawings in which:

FIG. 1 is a schematic diagram view of a manufacturing installation suitable for manufacturing a compound in a process according to the invention;

FIG. 2 is a diagram view comparing mechanical properties of different compounds comprising: a mixture of non-modified PHA and non-modified cellulose (each 50% of the total), a mixture of non-modified PHA and modified cellulose (each 50% of the total), and a mixture of non-modified cellulose with PHA, a certain fraction of which is grafted with maleic anhydride (PHA-g-MA);

FIG. 3 is a diagram view comparing mechanical properties achieved by different compounds comprising: a mixture of non-modified PHA (PHBH) with grafted polypropylene (PP-g-MA) and cellulosic fibres, and mixtures of cellulosic fibres with PHA (PHBH), a certain fraction of which is grafted with maleic anhydride in either soluble or powder forms;

FIG. 4 is a diagram showing comparative mechanical tests for three alternative compounds formed with a process according to the invention (including average value and standard deviation values).

### DETAILED DESCRIPTION OF THE INVENTION

The present invention concerns the compounding of a PHA polymer with cellulosic fibres, particularly with hardwood fibres having preferred length and density characteristics as indicated in the present specification and claims.

The inventors have discovered that a so-called process of “reactive compounding”, whereby the PHA polymer is first fed with maleic anhydride into an extruder for grafting of the two to produce a PHA-g-MA, and sequentially thereafter, cellulose fibres are fed in the same extruder for compounding with the PHA-g-MA just produced, is particularly beneficial, not only in terms of industrial and economic efficiency, but also in terms of the improved chemical and mechanical properties of the compound thus obtained.

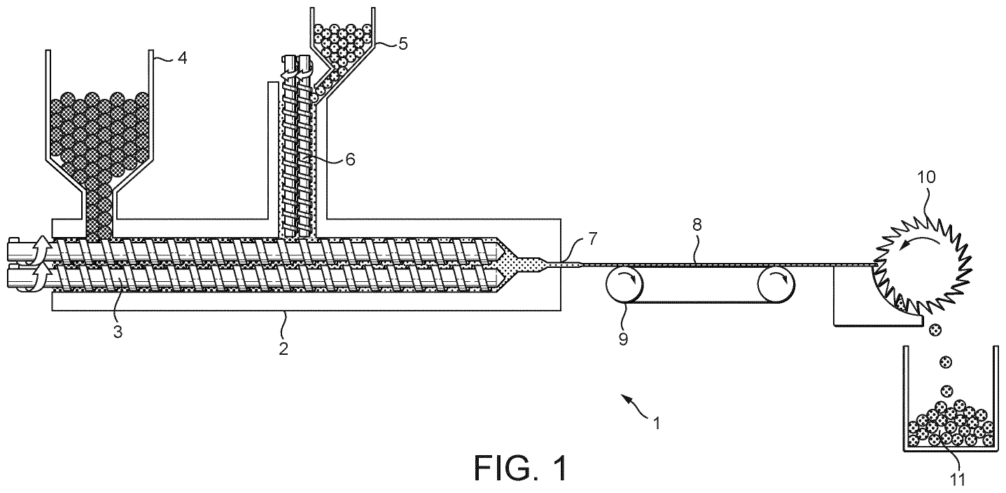

As illustrated in the embodiment of FIG. 1, the invention involves a single extruding process with an extruder 1, comprising a casing 2 and a screw 3 located therein. In the embodiment of FIG. 1, the extruder is a dual screw extruder with two screws rotating in opposing directions or in the same direction as indicated with arrows in FIG. 1.

The extruder further comprises a first feeding unit 4 and a second feeding unit 5. The two feeding units 4, 5 are preferably located at a distance from one another along the extruder length, that is predetermined and sufficient for the ingredients introduced in the first feeding unit to mix properly and react chemically completely inside the extruder, before they reach the location of the second feeding unit. This sufficient “time for reaction” of the ingredients fed in the first feeding unit can be predetermined appropriately and adjusted depending on the quantities of ingredients. An example of compound preparation is provided in greater details hereafter.

In the embodiment illustrated in FIG. 1 the second feeding unit comprises a pair of screws 6 for facilitating the introduction of the ingredient towards the extruder. This is particularly helpful when the ingredient is dry, or in a solid particles state which makes it difficult to flow in that case the set of screws facilitates the flow of said ingredient into the extruder.

When adding fibres in the second hopper, it is possible as alternatives to add the fibres either under the form of fibres or powders, but also alternatively under the form of compressed or pelletized fibres. Furthermore, one can also envisage to use a compatibilizer, and/or wetting or sizing agents.

The extruder 1 further comprises an extruder die 7 through which a cord 8 of hot extrudate material flows out, in the present embodiment, the extrudate cord is the compound of PHA-g-MA and cellulose fibres that is prepare inside the extruder.

After flowing out through the die 6, the cord of hot extrudate compound is chilled into a quenching station 9 comprising a water quenching bath (not illustrated in the drawing). The quenching bath is thermoregulated to a temperature of about 20° C., such that the cord of hot extrudate compound which flows out of the extruder in a molten state (i.e. at a temperature which is above the melting point of said compound), reaches a temperature lower than the melting point of the compound within a few seconds. The resulting compound cord comes out of the quenching bath in a solid state, and is then conveyed to a pelletizing station 10. In the pelletizing station 10, the extrudate cord 8 is cut into small pellets 11. The pellets are then packed and can be used as a compound for manufacturing packages with conventional packaging making processes (injection, extrusion-blow-moulding, lamination, compression, etc.).

In this exemplary embodiment, a PHBH-g-MA is produced as follows: 0.5 g of maleic anhydride (MA), 0.1 g of dicumyl peroxide (DCP), and 9.4 g of poly3-hydroxybutyrate-co-3-hydroxyhexanoate (PHBH) are mixed as grinded powders, or in acetone and subsequently acetone is evaporated. The powder mixture is then fed into the extruder (into the first feeding unit 4, as explained above), and kept in there for 5 minutes (starting when all the material is fed). The temperature of the extruder is set to 175° C.

After the 5 minutes have elapsed, the extruder is cooled to room temperature. At this stage, a clear color change of the polymer can be noticed, from colorless to yellow, which indicates the formation of PHBH-g-MA (which is of yellow color).

Prior to compounding with cellulose fibres, the PHBH-g-MA obtained is grinded with liquid nitrogen. Then, cellulose fibres (FC) are introduced into the extruder, through the second feeding unit 5, such that PHBH, FC and PHBH-g-MA are mixed. A lubricant additive (“Add.”), namely beeswax (BW) is added, the quantity of which is chosen between 3% and 8% by weight of the total compound.

The processing temperature for the extrusion and hot pressing is set between 175° C. and 180° C.

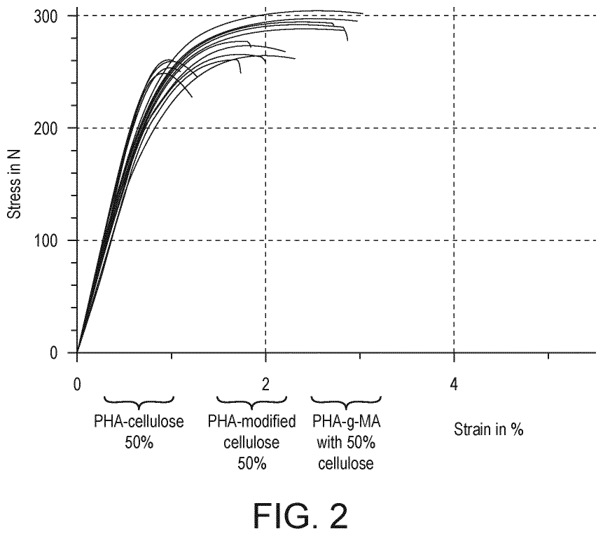

Turning to FIG. 2, the inventors have performed a set of comparative mechanical tests for elongation at break, in order to compare various combinations of ingredients and the resulting mechanical properties of the final compound thus obtained. The different alternative formulations tested and reported in FIG. 2 are as follows.

On the very left-hand side of the diagram, a PHA, not modified with maleic anhydride, is compounded with 50% by weight of cellulose fibers. The resulting compound shows a brittle mechanical behavior, indicated by a low strain in percentage compared to the stress withheld by the material.

Replacing the cellulose with a chemically modified cellulose (particularly a cellulose modified by AKD reaction according to the technique known in the art), allows to improve compatibility with the polymer, and consequently, the resulting compound displays an increased elongation at break.

However, the best results are observed (cf. the group of curves in the right-hand side of the diagram) with reactive compounding of PHA with maleic anhydride. In this case, a PHA-g-MA compounded with 50% by weight of the total compound of cellulose fibres, shows the greatest strain in % versus the stress applied to the compound material, i.e. between 2 and 4% of strain for a stress applied which amounts to 300 N.

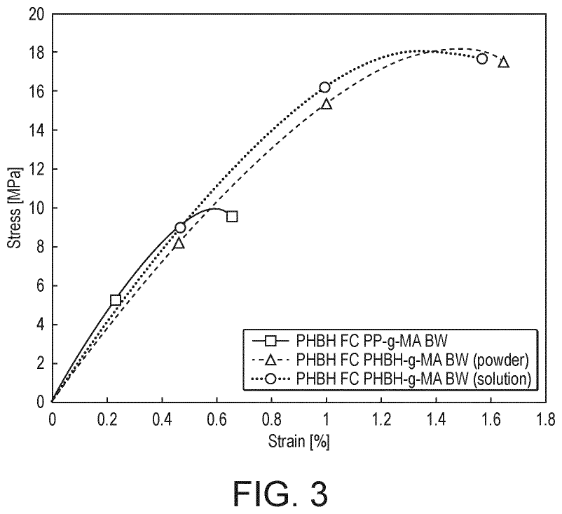

As illustrated in FIG. 3, a comparison in strain-stress tests of various compounds in tensile mode, revealed that PHBH-g-MA strongly improves the mechanical behavior of the final compound. For instance, by adding 3% of PHBH-g-MA by weight of the total compound, mechanical properties of the compound thus obtained are increased, versus compounds comprising only unmodified PHBH (not grafted to maleic anhydride) and cellulosic fibres. Whether the beeswax lubricant (BW) is added in solid or solution form does not substantially modify the results.

From the experiments, it is concluded that the interface between PHBH and cellulose is well mediated by PHBH-g-MA.

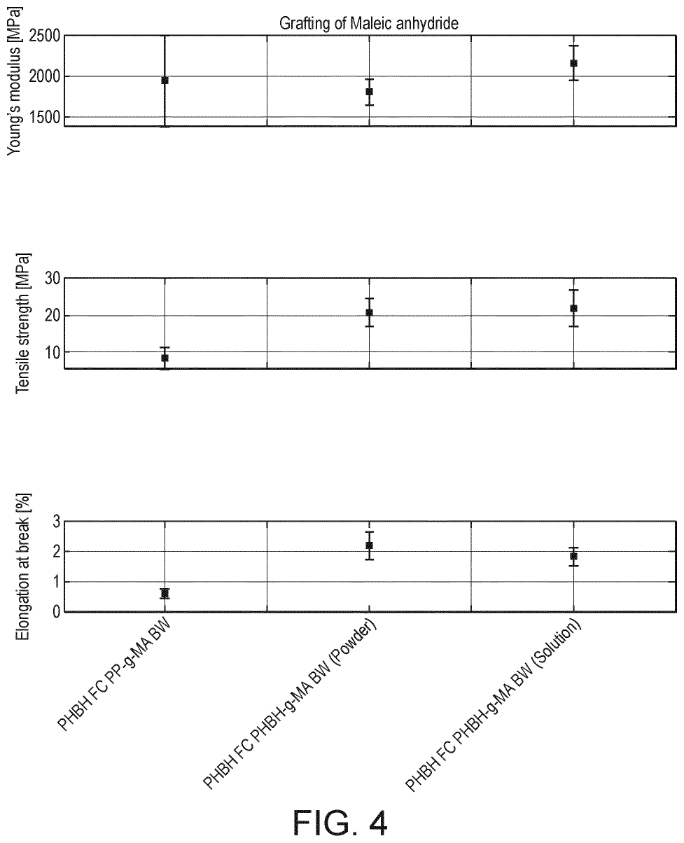

As illustrated in FIG. 4, comparative tests on three different compounds, namely:
PHBH with cellulosic fibres and polypropylene grafted with maleic anhydride (“PP-g-MA”),
PHBH with cellulosic fibres and PHBH grafted with maleic anhydride (PHBH-g-MA), together with beeswax as lubricant in powder form,
PHBH with cellulosic fibres and PHBH grafted with maleic anhydride (PHBH-g-MA), together with beeswax as lubricant in solution form,
shows that the compounding of PHBH and cellulose fibres with modified PHBH (PHBH-g-MA) improves all the mechanical properties of the final compound, in particular the Young's modulus, the Tensile Strength, and the Elongation at break.

### EXAMPLE

A typical example of a formulation for compounding a modified PHA (especially a PHBH) with cellulose fibres, is given hereafter. The amounts for each ingredient are indicated for each part of the extruder wherein they are introduced: first feeding unit (“feeder 1”) and second feeding unit (“feeder 2”).

| | |
|---|---|
| Feeder 1 | Feeder 2 |

| | | | | | |
|---|---|---|---|---|---|
| DCP | 0.006 | g | PHBH | 4.8 | g |
| MA | 0.03 | g | FC | 10 | g |
| PHBH | 4.564 | g | BW | 0.6 | g |
| Total | 4.6 | | Total | 15.4 | |

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

1. A process for manufacturing a biodegradable compound, said compound comprising a mixture of cellulosic fibres and at least one type of polyhydroxyalcanoate polymer (PHA), said process comprising the steps of, in order:
(i) providing an extruder comprising a heater, at least one rotating screw, at least two feeding units suitable for being fed with ingredients, and an extruder die, the temperature of said extruder being set between 130° C. and 190° C.,
(ii) feeding the first feeding unit with a PHA polymer and maleic anhydride (MA), wherein the ratio of maleic anhydride to PHA is comprised between 0.1 and 10,
(iii) feeding the second feeding unit with cellulosic fibres, said cellulosic fibres being hardwood cellulose fibres having a length of 15 μm to 150 μm, and having a density of at least 1.0 g/cm3,
(iv) rotating the at least one screw to mix the PHA and maleic anhydride ingredients and graft said maleic anhydride onto said PHA molecules to form PHA grafted with MA (“PHA-g-MA”) in an amount of 1 to 10%, of the total content of PHA, and then mixing said PHA-g-MA with cellulosic fibres to form a molten compound of PHA-g-MA and cellulosic fibres,
(v) passing said molten compound through said extruder die, and shaping said extruded compound into, a product selected from the group consisting of:
compound pellets, by cutting said extrudate compound cord with a knife system,
a compound film or compound plates (in this case, the extruder die takes the form of a cast line), and
a compound tridimensional item, by injection moulding or extrusion blow-moulding said extruded compound into a mould.

2. A process according to claim 1, wherein the extruder is a twin-screw extruder.

3. A process according to claim 1, wherein a catalyst is added together with the PHA and the maleic anhydride in the first feeding unit, said catalyst being selected from the group consisting of: dicumyl peroxide (DCP), benzoyl peroxide, dibenzoyl, hydroperoxides and ketone peroxides, and a combination thereof.

4. A process according to the preceding claim 3, wherein the ratio of catalyst to PHA is 0.01% to 5%.

5. A process according to claim 1, wherein a plasticizer is added together with the cellulosic fibres into the second feeding unit, said plasticizer being selected from the group consisting of: beeswax (BW), stearic acid (SA), glycerol monostearate (GMS), and a combination thereof.

6. A process according to the preceding claim 5, wherein the ratio of plasticizer to cellulosic fibre is 0.1% to 10%.

7. A process according to claim 1, wherein said polyhydroxyalcanoate polymer is selected from the group consisting of: poly3-hydroxybutyrate-co-3-hydroxyhexanoate (PHBH), poly-3-hydroxybutyrate-co-3-hydroxyvalerate (PHBV), poly-3-hydroxybutyrate (PHB), poly-3-hydroxyvalerate (PHV), or poly-3-hydroxyhexanoate (PHHx), and derivatives or combinations thereof.

8. A process according to claim 1, wherein the rotation speed of the at least one screw is comprised between 10 rpm and 300 rpm.

9. A process according to claim 1, which further comprises a step of quenching the extrudate compound within a quenching bath.

10. A process according to claim 9, wherein the temperature of said quenching bath (9) is between 5° C. and 50° C.

11. A process according to claim 9, wherein said quenching bath is water.
